(19) United States
(12) Patent Application Publication
(10) Pub. No.: US 2004/0256972 A1
(43) Pub. Date: Dec. 23, 2004

(54) Cathode ray tube

(76) Inventor: Oh-Yong Choi, Kumi (KR)

Correspondence Address: BIRCH STEWART KOLASCH & BIRCH, PO BOX 747, FALLS CHURCH, VA, 22040-0747, US

(21) Appl. No.: 10/698,357

(22) Filed: Nov. 3, 2003

(30) Foreign Application Priority Data
Jun. 17, 2003 (KR) 10-2003-0039201

(51) Int. Cl. H01J 29/80

(52) U.S. Cl. 313/407

(57) ABSTRACT

A cathode ray tube comprising a panel of which an outer surface is substantially flat; a shadow mask installed with a certain interval from an inner surface of the panel, having a plurality of apertures through which electron beams pass, and formed as a pin-cushion shape in which long and short sides of the shadow mask are inwardly concaved; and the mask frame for fixing and supporting the shadow mask, wherein long and short sides of the mask frame are slanted from ends toward centers thereof in order to maintain a predetermined interval with the long and short sides of the shadow mask. According to this, a strength of the shadow mask is increased and an influence of a magnetic field is reduced thus to obtain an optimum quality.

### BACKGROUND OF THE INVENTION

1. Field of the Invention

The present invention relates to a cathode ray tube, and more particularly, to a cathode ray tube capable of increasing a performance by optimizing a shape of a shadow mask and a mask frame.

2. Description of the Conventional Art

A cathode ray tube is a device for converting an electric signal into an electron beam and emitting the electron beam to a phosphor screen to realize an image. The cathode ray tube is widely used in the conventional art since excellent display quality is achieved at an affordable price.

A cathode ray tube will be explained with reference to attached drawings. FIG. 1 is a schematic view showing an example of a cathode ray tube of the conventional art. As shown in FIG. 1, the cathode ray tube includes a panel 201 of a front glass; a funnel 202 of a rear glass engaged to the panel 201 for forming a vacuum space; a phosphor screen 213 deposited on an inner surface of the panel 201 and serving as a phosphor; an electron gun 206 for emitting an electron beam 205 which makes the phosphor screen 213 emit light; a deflection yoke 207 mounted at an outer circumference surface of the funnel 202 with a predetermined interval for deflecting the electron beam 205 to the phosphor screen 213; a shadow mask 208 (hereinafter, a mask) installed at a constant interval from the phosphor screen 213; a mask frame 209 (herein after, a frame) for fixing and supporting the mask 208; and an inner shield 210 extending from the panel 201 to the funnel 202 for shielding external terrestrial magnetism and thus preventing deterioration of color purity by the magnetism.

Also, as shown in FIG. 2, the mask 208 includes a perforated portion 208b having a plurality of apertures 208a through which the electron beam 205 passes, and a skirt portion 208c extending from a periphery of the perforated portion 208b in the tube axis (Z-axis) direction for being fixed to the frame 209.

As shown in FIG. 3, the frame 209 is composed of a lateral wall portion 209c upright formed in the tube axis (Z-axis) direction and with which the skirt portion 208c is in contact for being fixed and supported. The lateral wall portion 209c consists of long sides 209a and short sides 209b having a predetermined length L and S, respectively.

The frame 209 not only fixes and supports the mask 208 inside the cathode ray tube but also absorbs and disperses a heat generated when the electron beam 205 impinges on the mask 208 in order to prevent a doming phenomenon that the mask 208 is expanded by the heat and thus to be round swelled. Also, the frame 209 absorbs and disperses an external impact in order to prevent the mask 208 from howling.

In the conventional cathode ray tube, the electron beam 205 emitted from the electron gun 206 is deflected by the deflection yoke 207, passes through the plurality of apertures 208a of the shadow mask 208, and lands on the phosphor screen 213 formed at the inner surface of the panel 201. Accordingly, the deflected electron beam 205 makes the phosphor formed at the phosphor screen 213 emit light, thereby achieving an image.

In accordance with a recent trend, the panel 201 becomes large and an outer surface thereof becomes flat, a size of the panel 201 becomes large and an area and a size of the mask 208 also become large. Accordingly, a structural strength of the mask 208 is lowered. Therefore, in order to enhance strength of the mask 208, a curvature of the mask 208 can be made to be greater than that of the inner surface of the panel. However, in this case, an impact resistance characteristic and a howling characteristic of the mask 208 cannot be basically improved.

### SUMMARY OF THE INVENTION

Therefore, an object of the present invention is to provide a cathode ray tube capable of increasing a strength of a shadow mask and obtaining an optimum quality of a screen by reducing an influence of a magnetic field, in which long and short sides of the shadow mask are slanted from ends thereof towards centers and long and short sides of a mask frame are slanted from ends towards centers in order to maintain a predetermined interval between the shadow mask and the mask frame.

Another object of the present invention is to provide a mask frame of a cathode ray tube capable of reducing a doming phenomenon of a shadow mask by optimizing a shape of the mask frame and thus fast transmitting and dispersing heat generated by impingement of the electron beam from the shadow mask to the mask frame.

Still another object of the present invention is to provide a mask frame of a cathode ray tube capable of improving a howling characteristic of a shadow mask by optimizing a shape of the mask frame and thus dispersing an external impact applied to the shadow mask to the mask frame.

To achieve these and other advantages and in accordance with the purpose of the present invention, as embodied and broadly described herein, there is provided a cathode ray tube comprising a panel of which an outer surface is substantially flat; a shadow mask installed with a certain interval from an inner surface of the panel, having a plurality of apertures through which electron beams pass, and formed as a pin-cushion shape in which long and short sides of the shadow mask are inwardly concaved; and the mask frame for fixing and supporting the shadow mask, wherein long and short sides of the mask frame are slanted from ends toward centers thereof in order to maintain a predetermined interval with the long and short sides of the shadow mask.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view showing a cathode ray tube in accordance with the conventional art;

FIG. 2 is a perspective view showing a shadow mask of a cathode ray tube in accordance with the conventional art;

FIG. 3 is a perspective view showing a mask frame of a cathode ray tube in accordance with the conventional art;

FIG. 4 is a schematic view showing a cathode ray tube according to the present invention;

FIG. 5 is a plan view schematically showing a state that a shadow mask of a pin-cushion shape and a mask frame of a rectangular type are assembled to each other;

FIG. 6 is a sectional view of a short axis (Y-axis) of FIG. 5;

FIG. 7 is a sectional view of a long axis (X-axis) of FIG. 5;

FIG. 8 is a graph showing a variation of intervals between a shadow mask and a mask frame from a diagonal periphery of the mask frame to centers of long and short sides in case that a pin-cushion shape shadow mask and a rectangular type shadow mask are applied;

FIG. 9A is a schematic view showing a phenomenon that a magnetic field passes along a closed surface;

FIG. 9B is a schematic view showing a phenomenon that a magnetic field passes through an object which is not a closed surface;

FIG. 10A is a schematic view showing a flow of a magnetic field applied from a right side to a left side of a cathode ray tube;

FIG. 10B is a schematic view showing a flow of a magnetic field applied from a front side to a rear side of a cathode ray tube;

FIG. 11 is a plan view schematically showing a state that a pin-cushion shape shadow mask and a pin-cushion shape mask frame are assembled to each other;

FIG. 12 is a graph showing a variation of intervals between a shadow mask and a mask frame from a diagonal periphery of the mask frame to centers of long and short sides according to shapes of the shadow mask and the mask frame;

FIG. 13 is a plan view showing measuring points for measuring an electron beam displacement due to a direction conversion of a magnetic field;

FIG. 14 is a graph showing an electron beam displacement in the left and right direction according to a shape of a mask frame at each point of a cathode ray tube of the present invention;

FIG. 15 is a graph showing an electron beam displacement of the front and rear direction according to a shape of a mask frame at each point of a cathode ray tube of the present invention;

FIG. 16 is a plan view schematically showing a shape that a pin-cushion shape shadow mask and a mask frame that a pin-cushion shape is applied in the vicinity of each center of long and short sides are assembled to each other in a cathode ray tube of the present invention;

FIG. 17 is a plan view schematically showing a shape that a pin-cushion shape shadow mask and a mask frame that a pin-cushion shape is applied in the vicinity of each end of long and short sides are assembled to each other in a cathode ray tube of the present invention; and

FIG. 18 is a plan view schematically showing a shape that a pin-cushion shape shadow mask and a mask frame that a pin-cushion shape is applied in the vicinity of each end of long and short sides are assembled to each other in cathode ray tube of the present invention.

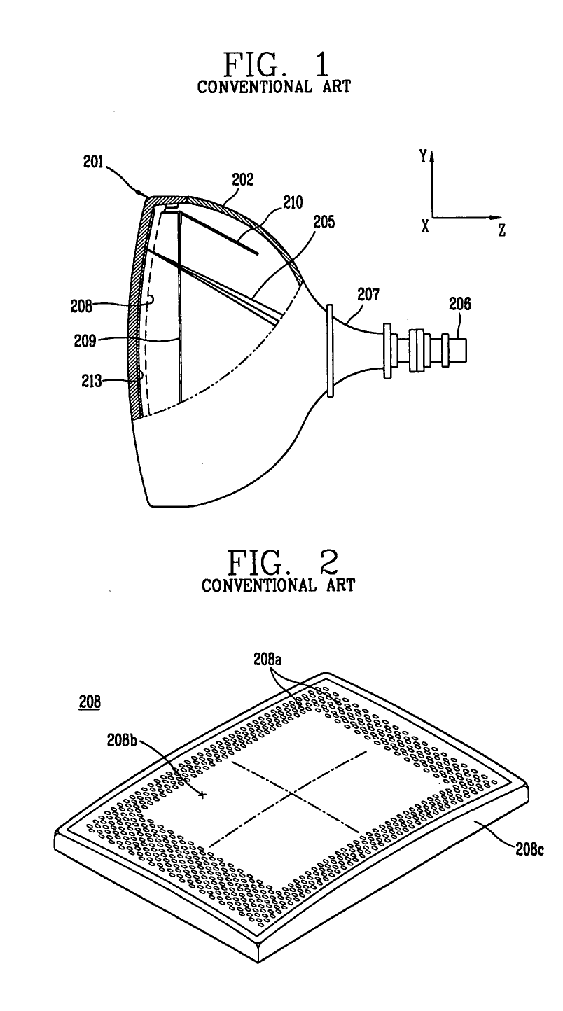

### DETAILED DESCRIPTION OF THE PREFERRED EMBODIMENTS

Reference will now be made in detail to the preferred embodiments of the present invention, examples of which are illustrated in the accompanying drawings.

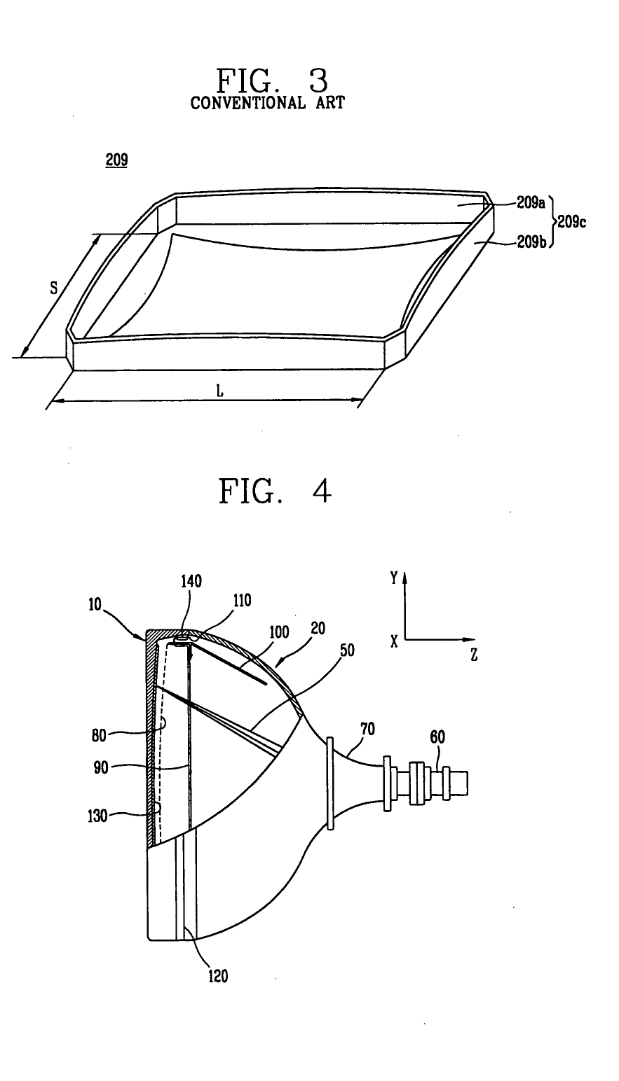

As shown in FIG. 4, the cathode ray tube (CRT) includes a panel 10 of a front glass of which an outer surface is a substantially flat, and an inner surface has a predetermined curvature; a funnel 20 of a rear glass engaged to the panel 10 for forming a vacuum space; a phosphor screen 130 deposited on an inner surface of the panel 10 and serving as a phosphor; an electron gun 60 for emitting an electron beam 50 which makes the phosphor screen 130 emit light; a deflection yoke 70 mounted at an outer circumference surface of the funnel 20 with a predetermined interval for deflecting the electron beam 50 to the phosphor screen 130; a shadow mask 80 (hereinafter, a mask) installed at a constant interval from the phosphor screen 130; a mask frame 90 (herein after, a frame) for fixing and supporting the mask 80; and an inner shield 100 extending from the panel 10 to the funnel 20 for shielding external terrestrial magnetism and thus preventing deterioration of color purity by the magnetism. The cathode ray tube also includes a stud pin 140 mounted at the inner side of the panel 10; a holder 110 connected to the stud pin 140 for elastically supporting the frame 90 to the panel 10; and a reinforcing band 120 arranged at an outer circumference of the panel 10 for distributing stress generated from the panel 10 and the funnel 20.

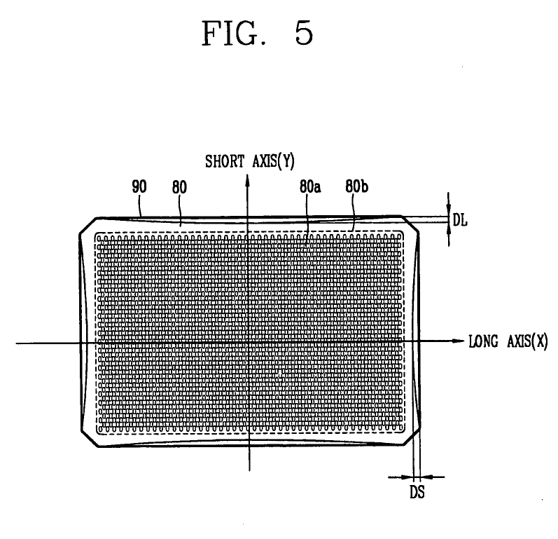

As shown in FIG. 5, the mask 80 includes a perforated portion 80b having a plurality of apertures through which the electron beam 50 passes, and the mask 80 is formed as a pin-cushion shape at the time of plane of projection, in which centers of long and short sides of the mask 80 are concaved towards an inside of the mask 80. Accordingly, a lowering of a structural strength of the mask 80 resulting from that the panel 10 becomes large and a curvature of the inner surface of the panel 10 is decreased is prevented.

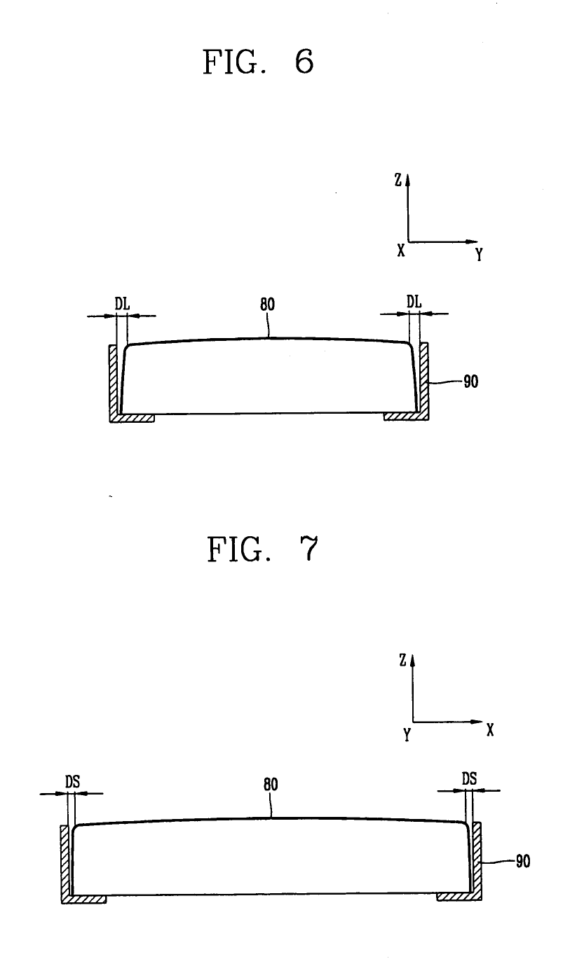

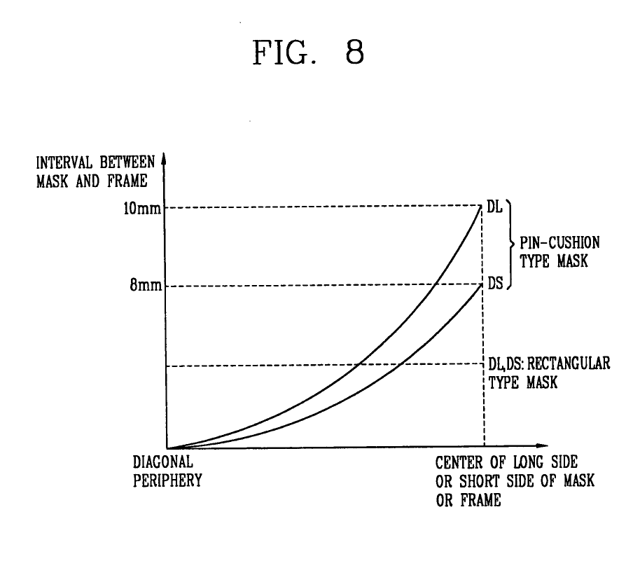

When the mask 80 is formed as a pin-cushion shape, as shown in FIGS. 6 and 7, predetermined intervals DL and DS between the long and short sides of the mask 80 and the long and short sides of the frame 90 are generated. As shown in FIG. 8, the intervals DL and DS between the mask 80 and the frame 90 become larger from each end of the long and short sides of the frame 90 toward each center of the long and short sides of the frame 90. Also, the intervals DL and DS have a maximum value at the respective center of the long and short sides of the mask 80 and the frame 90.

However, due to the intervals DL and DS, a heat transmission area of the frame 90 to which heat generated from the mask 80 is transmitted is reduced, so that the heat is not properly dispersed to the frame 90. Accordingly, time for lowering a temperature of the mask 80 is delayed and thus a doming amount due to a thermal expansion of the mask 80 is increased. Also, due to the intervals DS and DL between the mask 80 and the frame 90, when an external impact is applied to the mask 80, the impact is not properly dispersed to the frame 90. Accordingly, a howling characteristic, a phenomenon of the mask 80 trembling is deteriorated.

That is, as shown in a following table 1, in case that the mask 80 is changed from a rectangular type to a pin-cushion shape, a limitation gravity value within which the mask 80 is not deformed at the time of a drop test is increased from 16G to 19G thus to have an increased strength. However, as aforementioned, due to the intervals DS and DL of the mask 80 and the frame 90, a doming phenomenon and a howling characteristic of the mask 80 are deteriorated.

TABLE 1

| Type of Long and | Diagonal | | | |
|---|---|---|---|---|
| Short Sides of | Dimension of | | Doming | Howling |
| Shadow Mask | CRT (cm) | Drop Characteristic (G) | Phenomenon | Characteristic |
| Rectangular Type | 81 | 16 | good | good |
| Pin-cushion shape | 81 | 19 | bad | bad |

Also, the intervals DS and DL between the mask 80 and the frame 90 increase an influence of a terrestrial magnetic field and an external magnetic filed on the electron beam 50 thus to increase a displacement of the electron beam 50 susceptible to the magnetic field, thereby deteriorating a color purity of a screen.

That is, in case that the electron beam 50 passes through the funnel 20 by a deflection magnetic field of the deflection yoke 70, the inner shield 110 shields the terrestrial magnetic field and the external magnetic field thus to prevent the electron beam 50 from being displaced. However, in case that the electron beam 50 passes through the panel 10 via the mask 80, due to the intervals DS and DL between the mask 80 and the frame 90, the electron beam 50 is influenced by the terrestrial magnetic field and the external magnetic field and thereby its path is changed.

A force for converting a path of the electron beam 50 is defined as Lorentz force, and expressed as a following formula.

F=qV×B (1)

Herein, F denotes the Lorentz force, q denotes a charge quantity of particles, V denotes a velocity of charged particles, and B denotes a magnetic flux density.

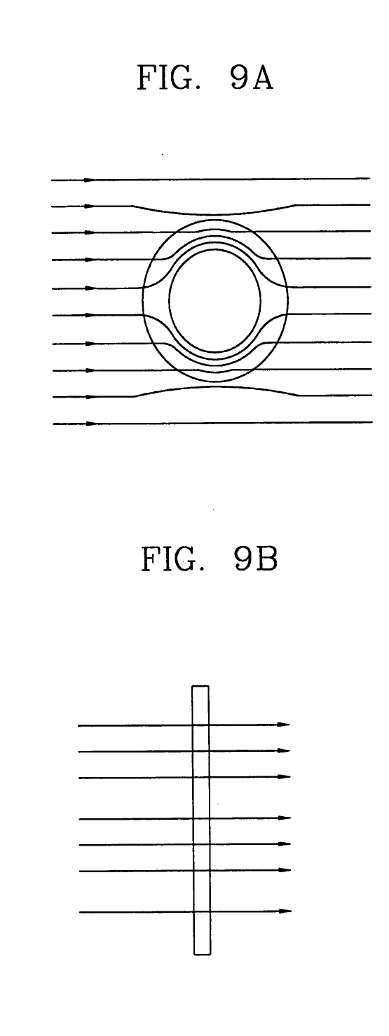

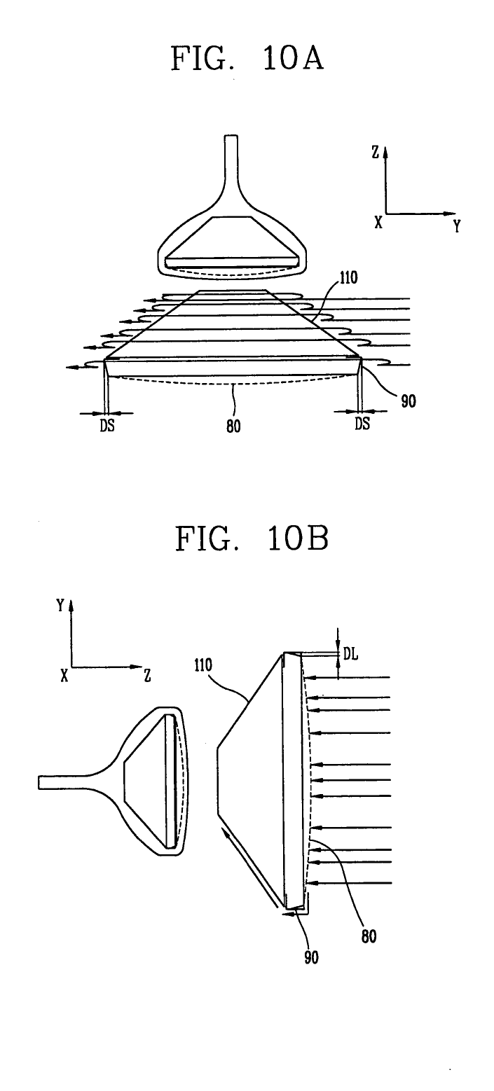

Generally, when a magnetic substance which can change a magnetic domain in an external magnetic field such as a terrestrial magnetic field is positioned at an external magnetic field, a magnetic field is formed in an opposite direction to the external magnetic field thus to make the inside of the cathode ray tube not become magnetic. Also, a phenomenon that a magnetic field flows out along a closed surface as shown in FIG. 9A and a phenomenon that a magnetic field directly passes through an object which is not a closed surface as shown in FIG. 9B are simultaneously generated. However, the inside of the cathode ray tube is not a material composed of a closed surface of a complete sphere type and components also become magnetic in a terrestrial magnetic field direction, so that a distortion of the electron beam path is inevitable. Therefore, as shown in FIGS. 10A and 10B, since the electron beam 50 is exposed to the magnetic field through the intervals DL and DS between the mask 80 and the frame 90, a displacement of the electron beam 50 is largely increased.

Following tables 2 and 3 show a displacement of the electron beam 50 according to an influence of the terrestrial magnetic field in case that the mask 80 is a rectangular type and a pin-cushion shape. Herein, DL denotes an interval between the center of the long side of the mask 80 and the center of the long side of the frame 90, and DS denotes an interval between the center of the short side of the mask 80 and the center of the short side portion of the frame 90.

TABLE 2

| Diagonal | | | |
|---|---|---|---|
| Dimension of | Type of Long and Short Sides of | | |
| CRT (cm) | Shadow Mask | DS (mm) | DL (mm) |
| 51 | Rectangular type | 1.1 | 1.1 |
| 58 | Rectangular type | 3.1 | 3.7 |
| 66 | Rectangular type | 2.6 | 2.6 |
| 68 | Rectangular type | 3.5 | 4 |
| 76 | Rectangular type | 2.6 | 2.6 |
| 81 | Pin-cushion shape | 7.7 | 10 |

As shown in table 2, in case that the mask 80 is formed of a pin-cushion shape, the intervals DS and DL become greater by approximately 2-3 times than in the rectangular type.

As shown in table 3, under three conditions that a case that a diagonal dimension of the cathode ray tube is 76 cm and the mask is a rectangular type, a case that a diagonal dimension of the cathode ray tube is 81 cm and the mask is a rectangular type, and a case that a diagonal dimension of the cathode ray tube is 81 cm and the mask is a pin-cushion shape, a vertical magnetic field is set as 0.35 gauss and a horizontal magnetic field is set as 0.3 gauss thus to measure the electron beam displacement of corner portions of the cathode ray tube according to a direction conversion of the vertical and horizontal magnetic fields. As the result, the electron beam displacement due to a direction conversion of a horizontal magnetic field was increased as approximately 30%, and the electron beam displacement due to a direction conversion of a vertical magnetic field was increased as approximately 27% in the cathode ray tube where the pin-cushion shape mask having great intervals between the mask and the frame is applied than in the cathode ray tube where the rectangular type mask is applied.

TABLE 3

| | | | | Electron | |
|---|---|---|---|---|---|
| | | | | Beam Displacement | |
| Diagonal | | | | according to direction | |
| Dimension | Type of Long and | | | conversion of terrestrial | |
| of | Short Sides of | DS | DL | magnetic field (μm) | |
| CRT (cm) | shadow mask | (mm) | (mm) | left [symbol] right | front [symbol] rear |
| 76 | Rectangular type | 2.6 | 2.6 | 40 | 80 |
| 81 | Rectangular type | 2.6 | 2.6 | 80 | 75 |
| 81 | Pin-cushion shape | 7.7 | 10 | 105 | 95 |

Accordingly, as aforementioned, in case of the pin-cushion shape mask, a howling characteristic and a doming characteristic of the mask are deteriorated due to the intervals DL and DS between the mask 80 and the frame 90, and a color purity of a screen is deteriorated due to an increased displacement of the electron beam 50 at the time of a direction conversion of a magnetic field.

In case that the mask 80 is formed as a pin-cushion shape, the intervals DL and DS between the mask 80 and the frame 90 become great. Accordingly, when the electron beam 50 passes through the panel 10, the frame 90 is easily exposed to a magnetic field, so that a displacement of the electron beam 50 is increased at the time of a direction conversion of the magnetic field and thereby a color purity of the cathode ray tube is deteriorated. Therefore, in order to reduce the intervals DL and DS between the mask 80 and the frame 90, the long and short sides of the frame 90 are respectively formed as a pin-cushion shape concaved towards an inside of the frame 90 corresponding to curvatures of the long and short sides of the mask 80.

That is, in order to maintain a predetermined interval between the mask 80 and the frame 90, a part of at least one side portion of the frame 90 is concaved inwardly.

The long and short sides of the frame 90 can be slantedly formed to have a predetermined angle toward the inside of the frame 90, or can be formed as a curved surface having a predetermined curvature. At this time, curvatures of the long and short sides of the frame 90 are formed to be smaller than those of the mask 80. Therefore, a curvature radius R1 of the long side and a curvature radius R2 of the short side of the frame 90 are formed to be greater than a curvature radius R3 of the long side and a curvature radius R4 of the short side of the mask 80. Also, the curvature radius R3 of the long sides of the mask 80 is formed to be greater than the curvature radius R4 of the short sides of the mask 80.

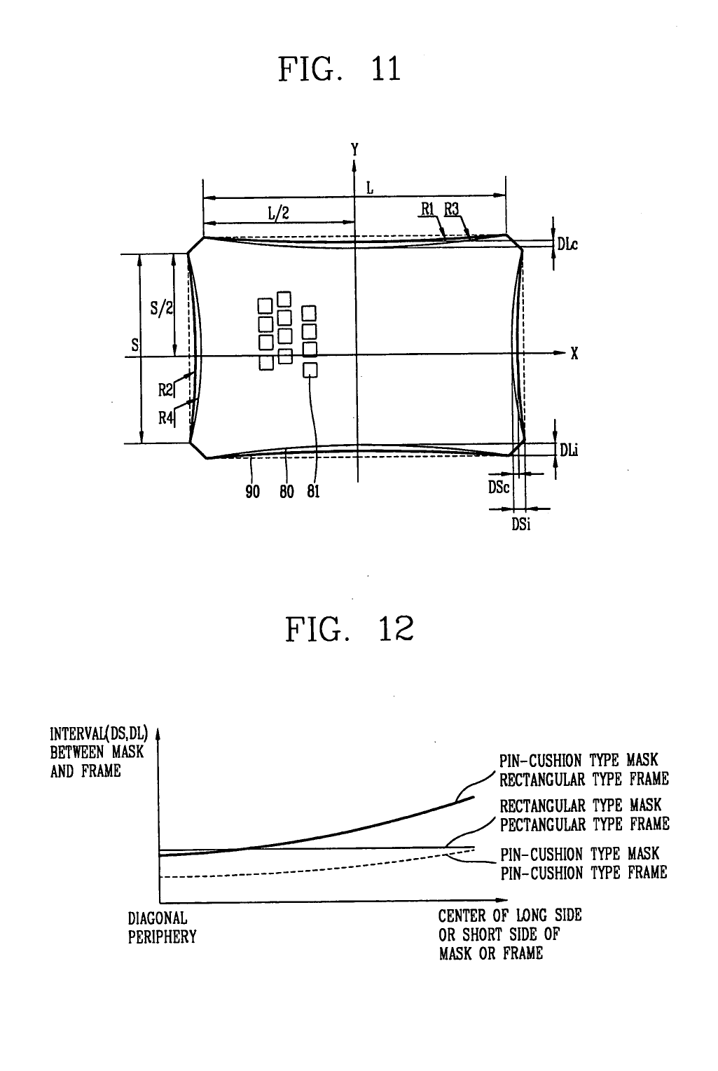

As shown in FIGS. 11 and 12, in case that the mask 80 and the frame 90 are formed as a pin-cushion shape, the intervals DS and DL between the mask 80 and the frame 90 become smaller than in a case that the mask 80 is formed as a pin-cushion shape and the frame 90 is formed as a rectangular type. Also, in case that the mask 80 and the frame 90 are formed as a pin-cushion shape, the intervals DS and DL between the mask 80 and the frame 90 become smaller than in a case that the mask 80 is formed as a rectangular type and the frame 90 is formed as a rectangular type.

A following table 4 shows a displacement of the electron beam 50 according to an influence of a terrestrial magnetic field in the cathode ray tube where the mask 80 is a pin-cushion shape. Herein, the DSc denotes an interval between the center of the short side of the mask 80 and the center of the short side of the frame 90, and the DLc denotes an interval between the center of the long side of the mask 80 and the center of the long side of the frame 90.

TABLE 4

| | | | | Electron Beam | |
|---|---|---|---|---|---|
| | | | | Displacement according | |
| Diagonal | | | | to direction conversion of | |
| Dimension | Type of Long and | | | terrestrial magnetic field | |
| of CRT | Short Sides of | DSc | DLc | (μm) | |
| (cm) | Shadow Mask | (mm) | (mm) | left [symbol] right | front [symbol] rear |
| 81 | Pin-cushion shape | 7.7 | 10 | 105 | 95 |
| 81 | Pin-cushion shape | 3.1 | 7 | 100 | 95 |
| 81 | Pin-cushion shape | 7 | 3.1 | 105 | 90 |

As shown in table 4, in the cathode ray tube where a diagonal dimension is 81 cm and the mask 80 is a pin-cushion shape, when the interval DSc between the center of the short side of the mask 80 and the center of the short side of the frame 90 is reduced from 7 and 7.7 mm to 3.1 mm, a displacement of the electron beam 50 according to a direction conversion of a horizontal magnetic field is decreased from 105 μm to 100 μm. Also, when the interval DLc between the center of the long side of the mask 80 and the center of the long side of the frame 90 is reduced from 7 and 10 mm to 3.1 mm, a displacement of the electron beam 50 according to a direction conversion of a vertical magnetic field is decreased from 95 μm to 90 μm. Accordingly, when the intervals DS and DL between the long and short sides of the mask 80 and the long and short sides of the frame 90 are reduced, a displacement of the electron beam according to an influence of a magnetic field can be decreased.

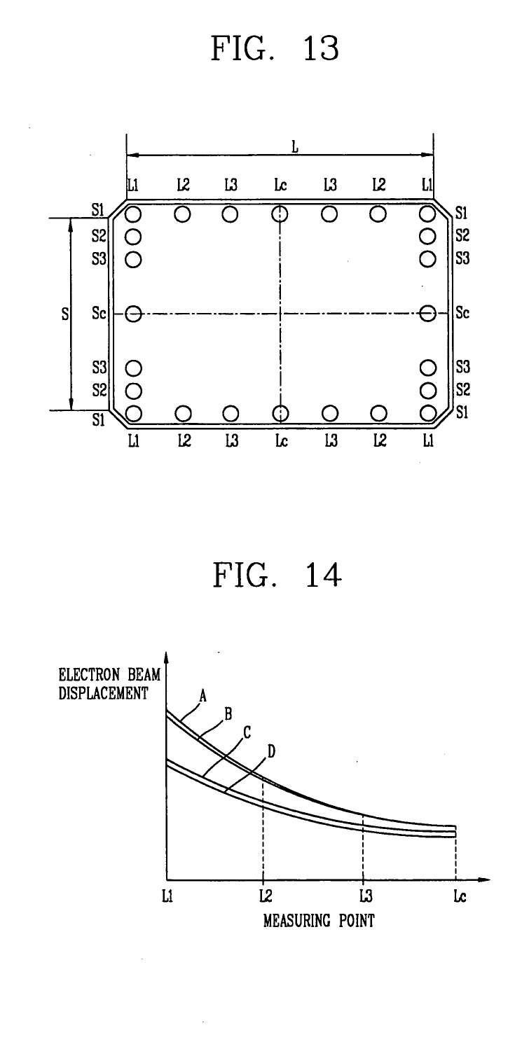

Hereinafter, in the cathode ray tube where the mask 80 is a pin-cushion shape, the electron beam displacement according to a direction conversion of a magnetic field measured at each point of the cathode ray tube by a shape of the frame 90 will be explained with reference to FIGS. 13 to 17.

FIG. 13 shows each point of the cathode ray tube where the electron beam displacement due to the magnetic field is measured. Herein, L1 and S1 denote positions near ends of the long and short sides of the frame 90, and L2 and S2 denote positions corresponding to approximately 30˜40% of lengths L/2 and S/2 between the ends of the long and short sides of the frame 90 and centers of the long and short sides, L3 and S3 denote positions corresponding to approximately 70% of lengths L/2 and S/2 between the ends of the long and short sides of the frame 90 and centers of the long and short sides, and Lc and Sc denote positions near centers of the long and short sides of the frame 90.

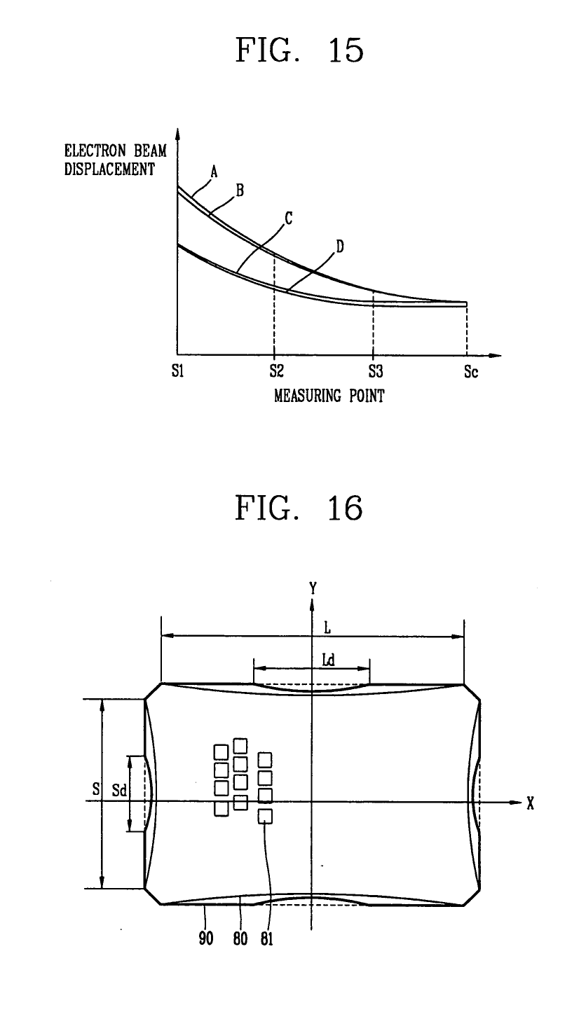

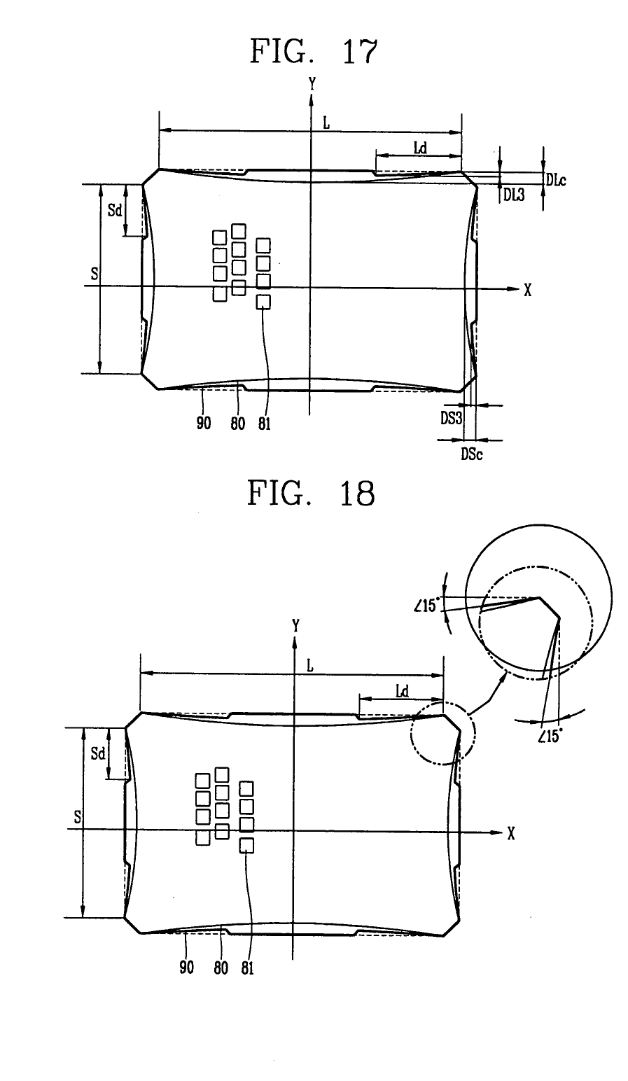

FIG. 14 is a graph showing an electron beam displacement in the left and right direction according to a shape of the frame 90 at each position of the cathode ray tube where the mask 80 is a pin-cushion shape, and FIG. 15 is a graph showing an electron beam displacement of the front and rear direction according to a shape of the frame 90 at each position of the cathode ray tube where the mask 80 is a pin-cushion shape. Herein, A is a case that the frame is a rectangular type, B is a case that a pin-cushion shape is applied in the vicinity of centers of the long and short sides of the frame 90 as shown in FIG. 16, C is a case that a pin-cushion shape is applied in the vicinity of the ends of the long and short sides of the frame 90 as shown in FIG. 17, and D is a case that a pin-cushion shape is applied from the ends of the long and short sides of the frame 90 to the center portions as shown in FIG. 11.

As shown in FIG. 14, the electron beam displacement of the left and right direction of cathode ray tube was decreased from the A type towards the D type at the time of a direction conversion of a magnetic field, in which the D type has a great difference of the electron beam displacement from the A and B types but has a little difference from the C type.

Also, as shown in FIG. 15, the electron beam displacement of the front and rear direction was decreased from the A type towards the D type at the time of a direction conversion of a magnetic field, in which the D type has a great difference of the electron beam displacement from the A and B types but has a little difference from the C type.

That is, the electron beam displacement due to the magnetic field is great at the ends of the long and short sides, that is, peripheries of the frame 90, than the centers of the long and short sides thereof. Also, the increased electron beam displacement by an influence of a magnetic field generated due to an increased interval between the mask 80 and the frame 90 is mainly shown at the periphery portions of the frame 90.

Accordingly, a decreased effect of the electron beam displacement of the C type frame where a pin-cushion shape is applied in the vicinity of the periphery of the frame 90, that is, ends of the long and short sides of the frame 90 of FIG. 17 is similar to that of the D type frame where a pin-cushion shape is applied to the entire long and short sides of the frame 90 of FIG. 11. Also, a position where a pin-cushion shape is applied in the C type frame 90 is preferably from the position L1 to the position L3 in case of the long sides and from the position S1 to the position S3 in case of the short sides. That is, the pin-cushion shape inwardly slanted from the ends of the long and short sides of the frame 90 towards the center thereof is preferably applied up to positions corresponding to approximately 70% of lengths L/2 and S/2 between the ends of the long and short side of the frame 90 and the centers thereof.

Also, as shown in FIG. 18, in the frame 90 where widths Ld and Sd having slanted angles from the ends of the long and short sides of the frame 90 towards the centers has sizes of 70% of the distances L/2 and S/2 between the ends of the long and short sides of the frame 90 and centers thereof, the slanted angles from the ends of the long and short sides of the frame 90 to the centers are less than about 15°, and more preferably, the slanted angels are less than about 10°.

A following table 5 shows an electron beam displacement according to an influence of magnetic field when the mask 80 is a pin-cushion shape. Herein, DS3 denotes an interval between the mask 80 and the frame 90 at a position corresponding to 70% of the distance S/2 from the end of the short side of the frame 90 to the center of the short side, and DL3 is an interval between the mask 80 and the frame 90 at a position corresponding to 70% of the distance L/2 from the end of the long side of the frame 90 to the center of the long side. Also, doming and howling characteristics applied to the mask 80 were expressed by being divided into three types, excellent, good, and bad.

TABLE 5

| | | | | | Electron Beam | | | |
|---|---|---|---|---|---|---|---|---|
| | | | | | displacement | | | |
| | | | | | according to direction | | | |
| | | | | | conversion of | | | |
| Diagonal | | | | | terrestrial magnetic | | | |
| Dimension | | | | | field (μm) | | | |
| of CRT | DSc | DLc | DS3 | DL3 | left [symbol] | front [symbol] | Doming | Howling |
| (cm) | (mm) | (mm) | (mm) | (mm) | right | rear | characteristic | characteristic |
| 81 | 7.7 | 10 | 5.5 | 8.0 | 105 | 95 | X | X |
| 81 | 7.7 | 10 | 5.5 | 3.0 | 105 | 70 | Δ | X |
| 81 | 7.7 | 10 | 2.6 | 8.0 | 65 | 93 | X | Δ |
| 81 | 7.7 | 3.1 | 5.5 | 3.0 | 105 | 68 | Δ | X |
| 81 | 7.7 | 3.1 | 2.6 | 8.0 | 65 | 90 | X | Δ |
| 81 | 3.1 | 10 | 2.6 | 8.0 | 63 | 95 | X | Δ |
| 81 | 3.1 | 10 | 5.5 | 3.0 | 100 | 70 | Δ | X |
| 81 | 7.7 | 10 | 2.6 | 3.0 | 64 | 69 | ⊚ | ⊚ |
| 81 | 3.1 | 3.1 | 5.5 | 8.0 | 100 | 90 | X | X |
| 81 | 3.1 | 3.1 | 2.6 | 3.0 | 62 | 67 | ⊚ | ⊚ |

⊚: excellent,
Δ: good,
X: bad

As shown from the first line of the table 5, in the cathode ray tube where a diagonal dimension is 81 cm and the mask is formed as a pin-cushion shape, in case that the intervals between the mask 80 and the frame 90 are not reduced, that is, in case that the intervals DLc and DSc between the centers of the long and short sides of the mask 80 and the centers of the long and short sides of the frame 90 are respectively 10 mm and 7.7 mm and the intervals DL3 and DS3 between the mask 80 and the frame 90 at positions corresponding to 70% of the distances L/2 and S/2 between the ends of the long and short sides of the frame 90 and the centers are respectively 8 mm and 5.5 mm, the electron beam displacement at the time of a horizontal magnetic field conversion is 105 μm, the electron beam displacement at the time of a vertical magnetic field conversion is 95 μm, and the doming and howling characteristics are bad.

On the contrary, as shown in the lowest line of the table 5, in case that the intervals between the mask 80 and the frame 90 are reduced by forming the frame 90 as a pin-cushion shape (D type), that is, in case that the intervals DLc and DSc between the centers of the long and short sides of the mask 80 and the centers of the long and short sides of the frame 90 are respectively 3.1 mm and the intervals DL3 and DS3 between the mask 80 and the frame 90 at positions corresponding to 70% of the distances L/2 and S/2 between the ends of the long and short sides of the frame 90 and the centers are respectively 3.0 mm and 2.6 mm, the electron beam displacement at the time of a horizontal magnetic field conversion is 62 μpm, the electron beam displacement at the time of a vertical magnetic field conversion is 67 μm, and the doming and howling characteristics are excellent.

That is, in case that the intervals between the mask 80 and the frame 90 are reduced by forming the frame 90 as a pin-cushion shape, the electron beam displacement due to the direction conversion of the horizontal magnetic field is reduced as approximately 40% from 105 μm to 62 μm and the electron beam displacement due to the direction conversion of the horizontal magnetic field conversion is reduced as approximately 30% from 95 μm to 67 μm.

Also, as shown in the third line from the bottom of the table 5, in case that the intervals between the mask 80 and the frame 90 are reduced only at position corresponding to widths Ld and Sd of approximately 70% of the distances L/2 and S/2 between the ends of the long and short sides of the frame 90 and the centers (C type), that is, in case that the intervals DLc and DSc between the centers of the long and short sides of the mask 80 and the centers of the long and short sides of the frame 90 are respectively 10 mm and 7.7 mm and the intervals DL3 and DS3 between the mask 80 and the frame 90 at positions corresponding to 70% of the distances L/2 and S/2 between the ends of the long and short sides of the frame 90 and the centers are respectively 3.0 mm and 2.6 mm, the electron beam displacement due to the horizontal magnetic field is 64 μm and the electron beam displacement due to the vertical magnetic field is 69 μm, which shows a similar effect to the D type mask that the intervals between the mask 80 and the frame 90 are reduced by forming the entire long and short sides of the frame 90 as a pin-cushion shape.

Accordingly, it can be seen that the electron beam displacement, the howling characteristic, and the doming phenomenon are decreased even in case that the intervals between the mask 80 and the frame 90 are reduced by forming the long and short sides of the frame 90 as a pin-cushion shape only up to positions corresponding to 70% of the distances L/2 and S/2 between the long and short side ends of the frame 90 and the centers.

That is, it is preferable that a width of the slanted portion of the long side slanted from the end of the long side of the mask frame toward the center thereof is equal to or larger than 70% of a width from the end of the long side of the mask frame toward the center thereof, and a width of the slanted portion of the short side slanted from the end of the short side of the mask frame toward the center thereof is equal to or larger than 70% of a width from the end of the short side of the mask frame toward the center thereof.

Meanwhile, in order to obtain the effect of the present invention, the interval DLc between the center of the long side of the mask 80 and the center of the long side of the frame 90 and the interval DSc between the center short side of the mask 80 and the center of the short side of the frame 90 have to be preferably smaller as approximately 50% than those of the conventional art. That is, in the cathode ray tube of the present invention, it is preferable that the intervals DLc and DSc between the centers of the long and short sides of the mask 80 and the centers of the long and short sides of the frame 90 have to be smaller than approximately 50% of intervals DLi and DSi between the centers of the long and short sides of the mask 80 and centers of imaginary lines connecting each end of the long and short sides of the frame 90 (the intervals between the centers of the long and short sides of the mask and the centers of the long and short sides of the frame in the conventional cathode ray tube). Also, as shown in the table 5, the intervals between the mask and the frame are maintained at least as 2.6 mm considering workability at the time of inserting the mask to the frame. The intervals between the mask and the frame are preferably formed to be equal to or larger than 2.6 mm. This can be expressed as following formulas.

0.3≦DLc/DLi≦0.5 (2)

0.3≦DSc/DSi≦0.5 (3)

Herein, DLi and DSi are intervals between the centers of imaginary lines connecting each end of the long and short sides of the frame 90 and the centers of the long and short sides of the mask 80.

Also, even in case that the intervals between the mask 80 and the frame 90 are reduced only up to positions corresponding to 70% of the distances between the long and short side ends of the frame 90 to the centers like in the C type, the intervals DL3 and DS3 between the mask 80 and the frame 90 at positions corresponding to 70% of the distances from the long and short side ends of the frame 90 to the centers are preferably smaller than approximately 50% of the intervals DLi and DSi which are between the centers of the imaginary lines connecting each end of the long and short sides of the frame 90 and the centers of the long and short sides of the mask 80. This can be expressed as following formulas.

0.3≦DL3/DLi≦0.5 (4)

0.3≦DS3/DSi≦0.5 (5)

In the cathode ray tube according to the present invention, the long and short sides of the shadow mask are inwardly concaved as a pin-cushion shape. Therefore, the structural strength of the shadow mask can be improved. Also, the long and short sides of the mask frame are inwardly concaved as a pin-cushion shape in order to correspond to curvatures of the shadow mask of a pin-cushion shape, so that an interval between the shadow mask and the mask frame is reduced and a predetermined interval is maintained. Accordingly, the electron beam displacement due to the magnetic field is decreased thus to prevent a color purity of a screen from being deteriorated and preventing doming and howling characteristics of the shadow mask from being deteriorated.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A cathode ray tube comprising:
a panel of which an outer surface is substantially flat;
a shadow mask installed with a certain interval from an inner surface of the panel, having a plurality of apertures through which electron beams pass, and formed as a pin-cushion shape in which long and short sides of the shadow mask are inwardly concaved; and
the mask frame for fixing and supporting the shadow mask, wherein long and short sides of the mask frame are slanted from ends toward centers thereof in order to maintain a predetermined interval with the long and short sides of the shadow mask.

2. The cathode ray tube of claim 1, wherein the long and short sides of the mask frame are curvedly formed to have predetermined curvatures from ends to centers thereof.

3. The cathode ray tube of claim 1, wherein following conditions are satisfied,
R1>R3, R2>R4,
in which R1 denotes a radius of curvature of the long side of the mask frame, R2 denotes a radius of curvature of the short side of the mask frame, R3 denotes a radius of curvature of the long side of the shadow mask, and R4 denotes a radius of curvature of the short side of the shadow mask.

4. The cathode ray tube of claim 3, wherein a following condition is satisfied,
R3>R4.

5. The cathode ray tube of claim 1, wherein following conditions are satisfied,
0.3≦DLc/DLi≦0.5, 0.3≦DSc/DSi≦0.5,
in which DLc denotes an interval between the center of the long side of the shadow mask and the center of the long side of the mask frame, DSc denotes an interval between the center of the short side of the shadow mask and the center of the short side of the mask frame, DLi denotes an interval between the center of the long side of the shadow mask and a center of an imaginary line connecting both ends of the long side of the mask frame, and DSi denotes an interval between the center of the short side of the shadow mask and a center of an imaginary line connecting both ends of the short side of the mask frame.

6. The cathode ray tube of claim 1, wherein a width of the slanted portion of the long side slanted from the end of the long side of the mask frame toward the center thereof is equal to or larger than 70% of a width from the end of the long side of the mask frame toward the center thereof, and a width of the slanted portion of the short side slanted from the end of the short side of the mask frame toward the center thereof is equal to or larger than 70% of a width from the end of the short side of the mask frame toward the center thereof.

7. The cathode ray tube of claim 6, wherein following conditions are satisfied,
0.3≦DL3/DLi≦0.5, 0.3≦DS3/DSi≦0.5,
in which DL3 denotes an interval between the mask frame and the shadow mask at a position corresponding to 70% of a distance from the end of the long side of the mask frame toward the center thereof, DS3 denotes an interval between the mask frame and the shadow mask at a position corresponding to 70% of a distance from the end of the short side of the mask frame toward the center thereof, DLi denotes an interval between the center of the long side of the shadow mask and a center of an imaginary line connecting both ends of the long side of the mask frame, and DSi denotes an interval between the center of the short side of the shadow mask and a center of an imaginary line connecting both of the short side of the mask frame.

8. The cathode ray tube of claim 1, wherein following conditions are satisfied
0°≦Lcor≦15° or 0°≦Scor≦15°,
in which Lcor denotes a slanted angle from the end of the long side of the mask frame toward the center thereof, and Scor denotes a slanted angle from the end of the short side of the mask frame toward the center thereof.

9. The cathode ray tube of claim 8, wherein a following condition is satisfied, 0°<Lcor≦Scor≦10°.

10. The cathode ray tube of claim 1, wherein an interval between the shadow mask and the mask frame is equal to or larger than 2.6mm.

11. A cathode ray tube comprising:
a panel of which an outer surface is substantially flat;
a shadow mask installed with a certain interval from an inner surface of the panel and having a plurality of apertures through which electron beams pass; and
a mask frame for fixing and supporting the shadow mask, wherein at least one of long and short sides of the mask frame is concaved toward and inside of the mask frame.

12. The cathode ray tube of claim 11, wherein at least one of the long and short sides of the mask frame is formed as curved surfaces having predetermined curvatures from the ends towards the centers.

13. The cathode ray tube of claim 11, wherein following conditions are satisfied,
R1>R3, R2>R4,
in which R1 denotes a radius of curvature of the long side of the mask frame, R2 denotes a radius of curvature of the short side of the mask frame, R3 denotes a radius of curvature of a long side of the shadow mask, and R4 denotes a radius of curvature of a short side of the shadow mask.

14. The cathode ray tube of claim 13, wherein a following condition is satisfied,
R3>R4.

15. The cathode ray tube of claim 11, wherein following conditions are satisfied,
0.3≦DLc/DLi≦0.5, 0.3≦DSc/DSi≦0.5,
in which DLc denotes an interval between a center of a long side of the shadow mask and a center of the long side of the mask frame, DSc denotes an interval between a center of a short side of the shadow mask and a center of the short side of the mask frame, DLi denotes an interval between the center of the long side of the shadow mask and a center of an imaginary line connecting both ends of the long side of the mask frame, and DSi denotes an interval between the center of the short side of the shadow mask and a center of an imaginary line connecting both ends of the short side of the mask frame.

16. The cathode ray tube of claim 11, wherein a width of the concaved portion of the long side of the mask frame is equal to or larger than 70% of a width from an end of the long side of the mask frame toward a center thereof, and a width of the concaved portion of the short side of the mask frame is equal to or larger than 70% of a width from an end of the short side of the mask frame toward a center thereof.

17. The cathode ray tube of claim 11, wherein following conditions are satisfied,
0.3≦DL3/DLi≦0.5, 0.3≦DS3/DSi≦0.5,
in which DL3 denotes an interval between the mask frame and the shadow mask at a position corresponding to 70% of a distance from an end of the long side of the mask frame toward a center thereof, DS3 denotes an interval between the mask frame and the shadow mask at a position corresponding to 70% of a distance from an end of the short side of the mask frame toward a center thereof, DLi denotes an interval between the center of the long side of the shadow mask and a center of an imaginary line connecting both ends of the long side of the mask frame, and DSi denotes an interval between the center of the short side of the shadow mask and a center of an imaginary line connecting both ends of the short side of the mask frame.

18. The cathode ray tube of claim 11, wherein following conditions are satisfied
0°≦Lcor≦15° or 0°≦Scor≦15°,
in which Lcor denotes a slanted angle from an end of the long side of the mask frame toward the center thereof, and Scor denotes a slanted angle from an end of the short side of the mask frame toward the center thereof.

19. The cathode ray tube of claim 18, wherein a following condition is satisfied, 0°<Lcor≦Scor≦10°.

20. The cathode ray tube of claim 11, wherein an interval between the shadow mask and the mask frame is equal to or larger than 2.6mm.
